(19) United States
(12) Patent Application Publication
(10) Pub. No.: US 2012/0221465 A1
(43) Pub. Date: Aug. 30, 2012

(54) CLEARINGHOUSE SYSTEM FOR MONETARY AND NON-MONETARY TRANSFERS OF VALUE

(76) Inventors: Victor V. Newsom, Las Vegas, NV (US); Hani Kolta Beshara, Las Vegas, NV (US)

(21) Appl. No.: 13/406,392

(22) Filed: Feb. 27, 2012

Related U.S. Application Data
(60) Provisional application No. 61/447,609, filed on Feb. 28, 2011.

(51) Int. Cl. G06Q 20/08

(52) U.S. Cl. 705/39

(57) ABSTRACT

A clearinghouse system facilitates the transfer of value of various forms, including monetary transfers, between parties as well as the monitoring and control of such transfers. The clearinghouse system may include a global framework that defines the operation of regional implementations of the system such that they may interoperate with a global hub of the system. The regional implementations may communicate with value exchange environments and client devices to facilitate, monitor, or control value transfers. A pending payments system is provided as well to effectuate direct transfers of value, including currency, between a consumer and merchant.

### 1. RELATED APPLICATION DATA

This application claims priority to U.S. Provisional Application Ser. No. 61/447,609, filed Feb. 28, 2011.

### BACKGROUND OF THE INVENTION

1. Field of the Invention

The invention relates generally to electronic payment systems, and in particular to a clearinghouse system capable of facilitating, controlling, and monitoring a wide variety of value exchanges or transfers.

2. Related Art

Despite many robust systems for monetary exchange and massive efforts for oversight and regulation, the rapidly expanding reach and capabilities of electronic systems to new users and new markets, the increasing ease for establishing proprietary relationships (social and financial), and the increase of transferring value (not currency alone) that may be consumed or even traded outside of its original financial region all combine to create fragmented rather than unified systems. The result of this fragmentation is the increase in cost to the entire economic and political system (and ultimately the consumer) as well as a lack of control and possibly destabilization of the monetary system.

Regulatory and Governmental response to these changes is increasingly challenged as the rate of introduction and level of complexity exceed the ability of these bodies to act (either proactively or re-actively) and to understand the implications of the policies and legislation they mandate. As an example: The last several years of debate and legislation over credit cards and the massive impacts that were only somewhat mitigated through retroactive changes show a tremendous lack of understanding and control on a subject that was many decades old. Worse, there is extensive collateral damage as other financial products were impacted.

There has been little clear understanding of the prepaid market (open, restricted access, or closed) nor is there a connection between phone minutes bought, sold, used, or transferred in the United States versus those transferred outside of the United States. Similarly, the size of the prepaid market has been largely apocryphal with various analysts creating definitions on the fly in an effort to make sense out of the complexities of various value types being exchanged across economic and political systems.

This lack of visibility, information, and understanding has led to less enlightened decision making, less effective policies, and even invisible forces being allowed to affect the marketplace. Cost, confusion, and consumer outrage are the most visible but not the worst of these effects. We are seeing the tip of the iceberg with telecommunications companies stepping into the role of financial service providers. India took an aggressive position to limit risk but many consider this to be at the expense of innovation. The European Union is attempting to guide change but have no real framework that supports regional implementations of policy in a uniform manner, and they continue to struggle at the country level due to issues of control, fear of bias, and lack of information.

In addition to the current issues described above, the rapid growth of social networks presents even large potential for disruption. For example an American telecom carrier that has 60 million customers has a large potential domestic impact, but a 500 million user social network across several countries has an even greater potential for disruption.

From the discussion that follows, it will become apparent that the present invention addresses the deficiencies associated with the prior art while providing additional advantages and benefits not contemplated or possible with prior art constructions.

### SUMMARY OF THE INVENTION

A clearinghouse system for transferring or exchanging monetary and non-monetary value is disclosed herein. In one or more embodiments, the clearinghouse system provides monitoring and control of transactions that are currently unmonitored, such as the transfer of non-monetary value. The clearinghouse system may also facilitate transfer of value between different parties and devices. In some embodiments, the clearinghouse system may function as or include a pending payment system to increase the variety of payment options that a consumer has when making a purchase from a merchant. In contrast to traditional payment systems, the pending payment system provides the advantage of a more direct and efficient transfer of value between a consumer and a merchant.

The clearinghouse system may have a variety of configurations as is detailed herein. For example, a clearinghouse system may comprise a global hub server, and one or more regional servers. The regional servers may be in communication with one or more value exchange servers and be configured to monitor transactions involving transfer of non-monetary (or monetary) value at the one or more value exchange servers. The regional servers may report the transactions to the global hub server for analysis or reporting.

A global framework defining data formats for communication between at least the global hub server and the one or more regional servers may be used to ensure interoperability between regional servers and the global hub. The global framework may be stored on a storage device accessible to the one or more regional servers. Using the global framework a variety of regional servers can collect disparate transaction information based on regulations, policies, or other rules of a particular region or jurisdiction while being able to communicate transaction information with a remote global hub.

In another example embodiment, the clearinghouse system may comprise a pending payment server configured to communicate with at least one consumer payment device and at least one merchant payment device. The pending payment server may receive a request for payment from the consumer and merchant payment devices and also receive an acceptance or denial of the request for payment from the consumer payment device. An application programming interface may be implemented on the pending payment server. The application programming interface may define the data format for communication with the pending payment server.

One or more communication links may be between the pending payment server and one or more value exchange servers that are not available on the merchant payment device. The pending payment server may instruct the value exchange servers to transfer monetary value to one or more merchants through the one or more communication links. In this manner, the merchant may accept payment types that are otherwise unacceptable at the point of sale.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating an exemplary clearinghouse system;

FIG. 2 is a block diagram illustrating components of an exemplary clearinghouse system;

FIG. 2A is a block diagram illustrating another exemplary clearinghouse system;

FIG. 3 is a block diagram illustrating an environment of use for an exemplary regional implementation of a clearinghouse system;

FIG. 4 is a block diagram illustrating an exemplary regional implementation of a clearinghouse system;

FIG. 5 is a block diagram illustrating an implementation of an exemplary clearinghouse system;

FIG. 5A is a block diagram illustrating another implementation of an exemplary clearinghouse system;

FIG. 6 is a flow diagram illustrating the operation of an exemplary clearinghouse system;

FIG. 7 is a block diagram illustrating physical payment schemes;

FIG. 8 is a block diagram illustrating processes for implementing and operating traditional payment schemes;

FIG. 9 is a block diagram illustrating electronic payment according to an exemplary pending payment system;

FIG. 10 is a block diagram illustrating an implementation of an exemplary pending payment system;

FIG. 11 is a flow diagram illustrating operation of an exemplary pending payment system;

FIG. 12 illustrates graphical user interfaces of payment devices of an exemplary pending payment system;

FIG. 13 is a flow diagram illustrating operation of an exemplary pending payment system;

FIG. 14 is a block diagram illustrating brick and mortar transactions at an exemplary pending payment system;

FIG. 15 is a block diagram illustrating online transactions at an exemplary pending payment system;

FIG. 16 is a block diagram illustrating regional integration with a transportation ticket purchase system at an exemplary pending payment system;

FIG. 17 is a block diagram illustrating regional integration with a transportation ticket redemption/use system at an exemplary pending payment system; and

FIG. 18 is a block diagram illustrating regional integration with various ticketing systems.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

With a widely recognized shift to mobile devices as the future of electronic transactions and the medium most likely to attack (e.g., reduce or replace) cash usage, there is an opportunity to provide a government and regulatory friendly solution to the exchange of value between parties with minimal disruption to traditional methods of value exchange. One embodiment of the invention comprises a clearinghouse system and method for facilitating and tracking monetary and non-monetary transfers of value. In general, the clearinghouse system disclosed herein provides a wide ranging and versatile system for facilitating and monitoring value exchange even where value is exchanged by methods other than monetary exchange. In addition, because the system receives or imports data from virtually any external scheme, the system herein is capable of monitoring, enforcing, and adjusting regulatory policy based on information rather than special interest representation or guesswork.

In one embodiment, the clearinghouse system provides a highly versatile system capable of facilitating, monitoring, and/or controlling value exchange at mobile devices, such as smart phones, PDAs, cell phones, tables, and other mobile computing devices. The clearinghouse system is capable of servicing a wide geographic area a wide variety of similar or dissimilar value exchanges. For example, the clearinghouse system may service value exchange in the form of currency transactions, credit transactions, prepaid transaction, phone minutes, and exchange of other electronic or non-electronic items of value. It is contemplated that the clearinghouse system may service one or more regions or even function globally.

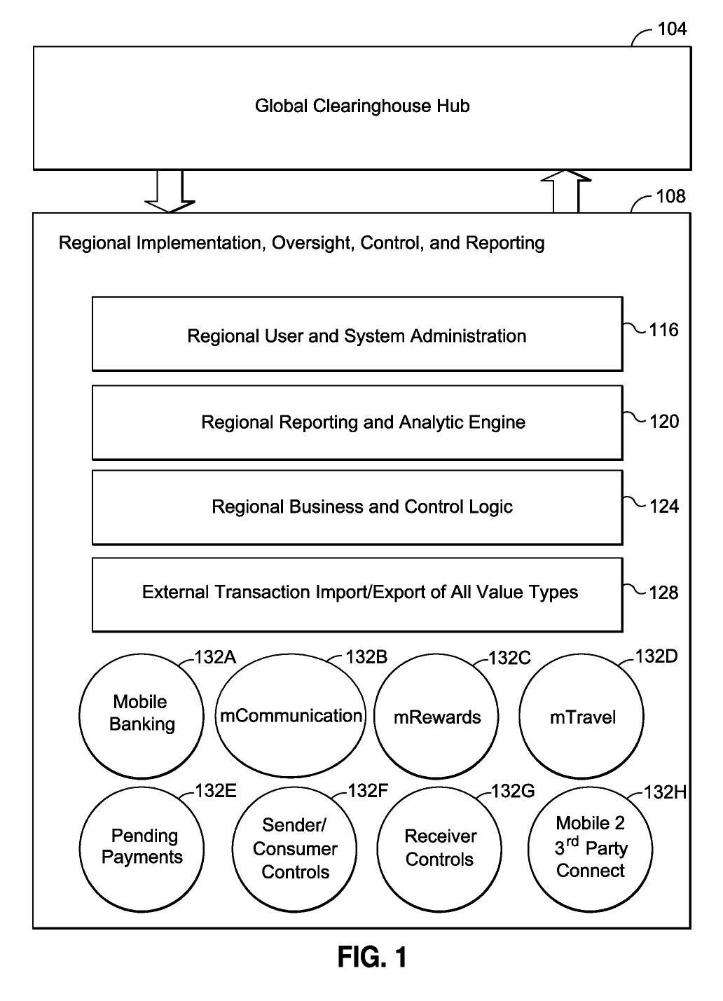

Referring to FIG. 1, the foundation of the clearinghouse system may be a common set of tools or global framework that can be centrally maintained. Use of the global framework provides complete interoperability/compatibility with components of various local economic or political systems or regions, such as regional implementations of the clearinghouse system. In other words, the global framework may provide a set of one or more standards to which participants in the clearinghouse to system may comply. These standards may be used to allow at least a minimum level of interoperability and compatibility between hardware and/or machine readable code used to implement the clearinghouse system, even where such hardware is geographically remote and/or implemented by separate parties.

In one or more embodiments regions may be geographic areas of various sizes and shapes. Regions may be defined by governmental or regulatory jurisdictions or political divisions. For example, a region may be defined by the jurisdiction or applicable area of one or more rules, regulations, or laws. These regions may be embodied by borders, such as borders between counties, cities, states, provinces, countries, territories, continents, and the like. Regional implementations are highly advantageous in that they allow the clearinghouse system to serve individual regions within the applicable rules, regulations, and laws of the individual regions. In this manner, value transfers may be facilitated, monitored, or controlled on a region by region basis. For example, value transfers may be monitored within individual cities for the purpose of tax collection at the (same or different) rates defined by the cities. At the same time value transfers may be monitored for other regions, such as counties, states, or even countries. It is noted that regions may overlap. For example, one region might comprise the municipality of New York City (which may wish to monitor value transactions occurring within the city for purposes of the applicability of city tax) and another region might comprise the State of New York (which overlaps with New York City).

As shown in FIG. 1 for example, a global clearinghouse hub 104 may communicate with one or more regional implementations 108 of the clearinghouse system, as will be described further below. Interoperability between various regional implementations 108 and the global hub 104 will allow for the consolidation of value transactions of virtually any type. In this manner, international governance may be supported more effectively than is possible today both due to visibility into monetary transactions via channels that are currently unmonitored as well as into alternate value exchanges that are unaccounted for today.

Though the global framework serves as a foundation, it is noted that regional variations may make the adoption of a single solution or standard problematic, if not impossible. Regional implementations 108 allow for regional customization of the clearinghouse system without losing interoperability. For example, reports, controls, alerts, business logic and administration may be customized to meet regional needs. For example, a regional reporting and analytic engine 120 may be provided for these purposes. Additionally, while interoperability is preserved, certain transaction types may be limited or prevented. This provides for full control over transactions inside and across the region's boundaries (for system based transactions) as well as monitoring/tracking transactions and response to transactions imported from external systems.

Within each regional implementation 108, there will typically be a set of common components as well as unique components added over time to serve ongoing and emerging needs. This allows regions to add, modify, or remove components to their regional implementation 108 as needed or as desired, such as adding, modifying, or removing regional business and control logic 124 as shown in FIG. 1. In keeping with need to add value to the end user as well as the core value of interoperability, the clearinghouse system may support the presentation and delivery of third party features as well. These features may be added (and modified/removed) as regional business and control logic 124 in some embodiments.

A regional user and system administration engine 116 may also be part of a regional implementation. In one embodiment, the regional user and system administration engine 116 may be configured to allow configuration of administrative settings, such as user accounts, rights, and privileges within a region.

As can be seen, a regional implementation 108 may support (facilitate and/or track) various transaction types dealing with the transfer or exchange of value. Some exemplary transaction types 132A-132H are shown in FIG. 1. A regional implementation 108 may include transaction monitoring features. For example, an external transaction monitor 128 may be configured to communicate information regarding transactions, such as by importing and exporting transaction information detailing the transfer or exchange of value from various payment systems. To illustrate, the external transaction monitor 128 may import and export transaction information from mobile banking systems, rewards systems, travel systems, pending payment systems, and other systems which store or process items of value.

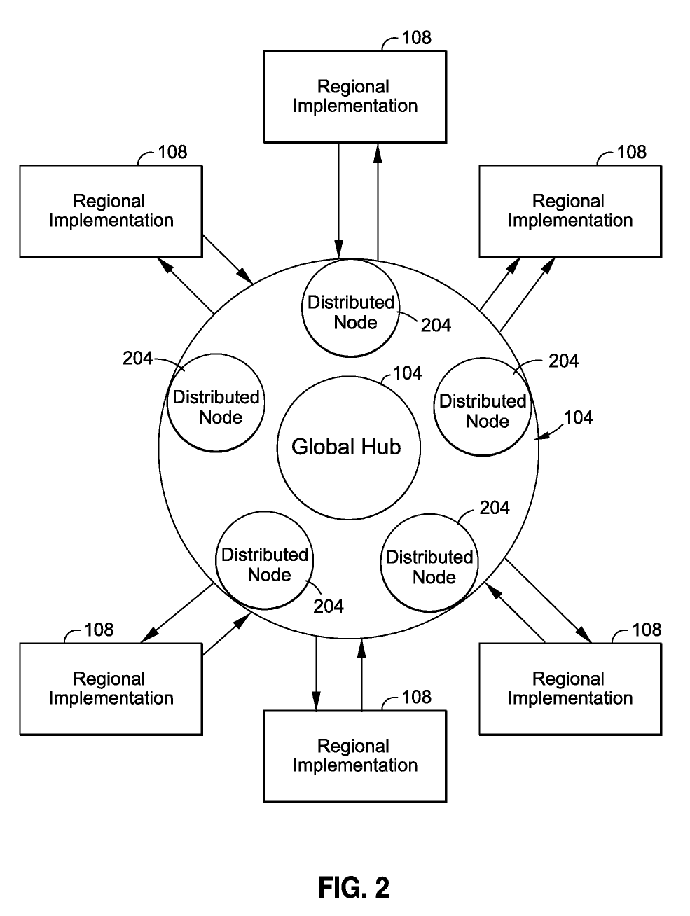

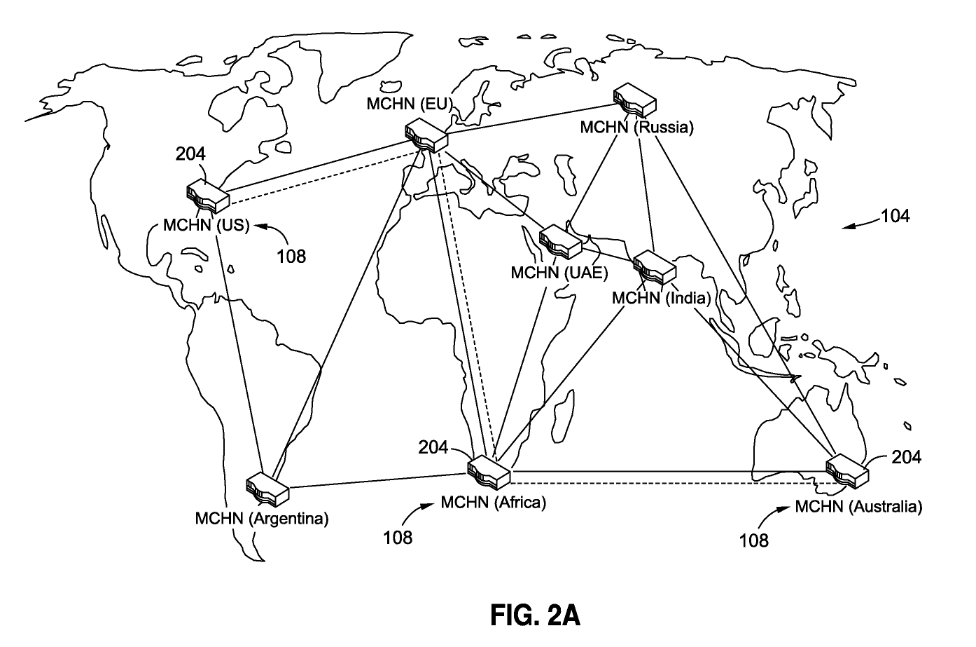

Referring to FIG. 2, the global framework may be implemented by hardware, software, and relationships with leading entities (e.g., financial institutions, governments, corporate entities) within a region. The hardware may be centralized in one or more embodiments, such as in a global hub 104 as shown. Alternatively or in addition, the hardware may utilize cloud computing concepts for high availability, scalability, and cost-effectiveness. For example, individual regions may require data storage or processing to occur, in whole or in part, within certain geographic boundaries. Such storage or processing may occur in distributed nodes 204, such as those shown in FIG. 2. The global hub 104, therefore, may include or comprise both a core or central global hub as well as any distributed nodes 204 in one or more embodiments.

The hardware may execute machine readable code including a set of “standard tools”, a flexible architecture with common communication protocols, deployment and support of regional implementation 108 (such as the use of ISO8385, ISO20022xml, NACHA, SEPA, or other communication protocols which are required for integration into and interoperability with the existing financial services infrastructure) and robust transaction switching, processing, and reporting capabilities. This machine readable code may be stored on a non-transient memory device readable by the hardware. Therefore, it can be seen that a regional implementation 108 may be implemented by hardware and machine readable code. The regional implementation 108 may be integrated into or customized for the local environment according to the objectives of a client.

In keeping with the goals identified above, the global framework may include leading entities in each region that are positioned to integrate the regional implementation 108 into the local environment/region with financial as well as political support.

FIG. 2A illustrates a preferred embodiment of a global framework wherein the framework is distributed. For example, the global framework may comprise a plurality of distributed nodes 204 wherein each node is associated with a particular regional implementation. In such a configuration, the global hub 104 is not a single server or location, but simply a mechanism for central administration, control and oversight. In such a configuration, rules, updates and other data may be delivered or pushed to each regional implementation 108 through its associated distributed node 204. At the same time, each regional implementation 108 may deliver or transmit data to its distributed node 204, such as for warehousing. Notably, in such a configuration, transactional and other data may be transmitted between the various distributed nodes 204 (i.e. rather than to a central hub). For example, relative to the example illustrated in FIG. 2A, transactional data may be directly transmitted between the MCHN Africa regional implementation 108 and the MCHN Australia regional implementation 108 through their associated distributed nodes 204. However, if such a link is not possible, the transactional data could be exchanged indirectly, such as via a link through the distributed node 204 associated with the MCHN India regional implementation 108.

This configuration allows data to follow the best path between a source and a destination, whether such is a direct or indirect path rather than through a single central hub. At the same time, however, the administration of the distributed nodes 204 and the regional implementations 108 can be managed centrally and data can be collected centrally. This allows for global oversight and scalability, while at the same time allowing separate regional control (i.e. independent management of each regional implementation).

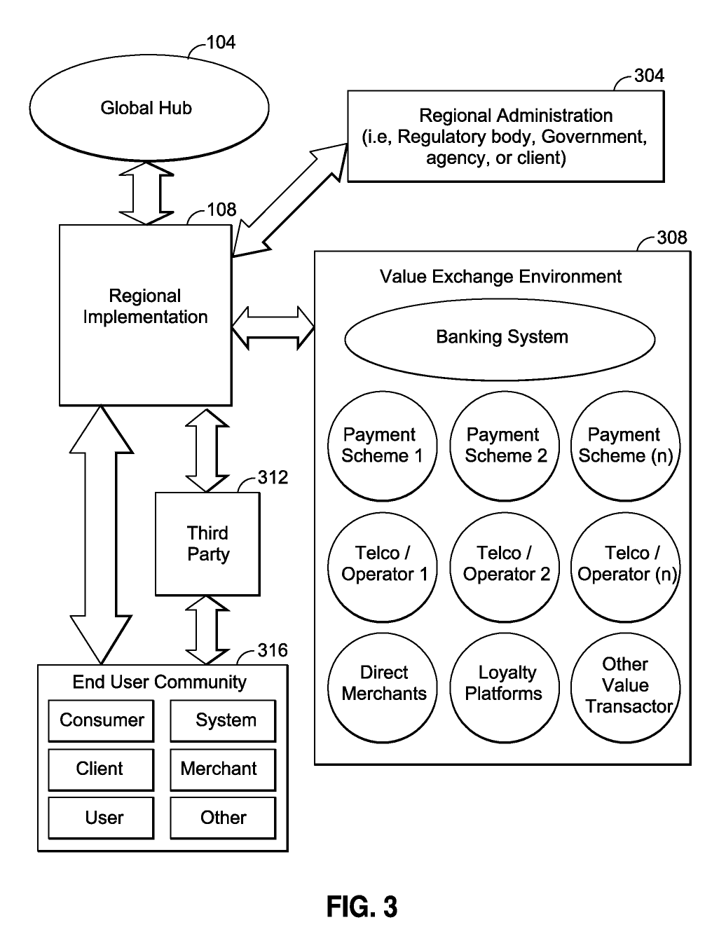

FIG. 3 illustrates an external view of the regional implementation 108 showing the environment in which a regional implementation may be used. As described above, a regional implementation 108 may be connected to a global hub 104. In addition, a regional implementation 108 may be connected to the transactional and reporting interfaces of various value exchange systems 308, regional administration systems 304, and end users 316 directly or indirectly through one or more third parties 312. These connections are envisioned to occur across a variety of communication/data links, devices, and protocols.

For example, system and device level connections may occur through various standard or proprietary communications protocols set forth within a global framework. In addition, connections may be made through the translation of external standards such as ISO8385, ISO20022xml, Secure FTP, proprietary Application Programming Interfaces (APIs), NACHA, PEACHA, SEPA, HTTP, HTTPS, RFID, NFC, SMS SMTP, MIME, USSD, etc. . . . into a format defined within the global framework.

One or more graphical user interfaces (GUIs) may be used to interact with and/or control various parts of the clearinghouse system. GUIs may be both on the internal systems or hosted externally and developed and maintained via a variety of technologies depending on the end user and client needs and local environmental factors to provide mobile and fixed computing platforms (e.g., PC Browser Based, WAP, JAVA, RIM, Brew, Apple iOS, etc. . . . ) This allows hardwired, wireless, or plug-in devices such as PDAs, cell phones, smart phones, POS terminals, ATMs, IP enabled smart devices, chip based cards or similar devices, SIM card enabled devices, NFC devices, RFID devices, infrared devices, laser or similar optical based devices, faxes, printers, scanners, voice telephones, VOIP based phones, etc. . . . to interact with the clearinghouse system by end users or administrators. It is noted that alerts and reports may be distributed in a variety of formats as needed such as PDF, HTML, text, CSV, or other proprietary or non-proprietary formats.

In operation, a regional implementation 108 may facilitate value exchanges. For example, the regional implementation 108 may facilitate communication between end users 316 and a value exchange environment 308 to execute a value exchange. To illustrate, a transfer of prepaid currency, phone minutes, frequent flier miles, or other items of value may occur with the regional implementation 108 serving as a communications hub between an end user 316 and a value exchange environment 308, such as a prepaid currency, cellular service provider, or airline mile processing system. In such embodiments, the regional implementation 108 may monitor value exchanges that it is facilitating by monitoring the communications it is facilitating between end users 316 and value exchange environments 308. The regional implementation 108 may also control, such as by preventing, certain transactions from occurring in this manner.

It is contemplated that the regional implementation 108 may allow value exchanges or transfers that would not otherwise be possible. For example, the regional implementation 108 may permit an end user 316 to exchange frequent flier miles for phone minutes in some embodiments.

In operation, the regional implementation 108 may alternatively function as a transaction monitoring and/or control system. For example, the regional implementation 108 may monitor transactions between end users 316 and value exchange environments 308 via one or more communications links, such as shown in FIG. 3. Transactions that are illegal or not permitted may be blocked by the regional implementation 108 or identified to regulatory or other authorities. For example, the regional implementation 108 may transmit a notification to the value exchange environment 308 or end user 316 that causes their systems/devices to refuse or reject a transaction, and/or to inform the end user or value exchange environment that the transaction is not permitted. In addition, the regional implementation 108 may transmit a notification to regulatory or other authorities regarding the transaction, so that they may take action.

It is noted that the regional implementation 108 may function solely as a monitoring system in some embodiments. For example, the regional implementation 108 may simply receive transaction information from end users 316, value exchange systems 308 or both to make a record of such transactions for analysis. This is beneficial in that it permits regulatory or governmental authorities to make informed policy decisions regarding regulation of value exchange. It is contemplated that the authorities may utilize this information to determine tax rates for example.

The operation or configuration of a regional implementation 108 may be controlled by a regional administration system 304, as is shown in FIG. 3. The regional administration system 304 may itself be controlled by administrators, such as regulatory bodies, governmental agencies, or other clients. The regional administration system 304 may provide a GUI or other interface through which the operation of the regional implementation 108 may be controlled. For example, the GUI may change the operation of a regional implementation 108 such that it controls and monitors value exchanges rather than only monitoring them, or vice versa. In addition the GUI may permit administrators to define transactions that are or are not permitted by the regional implementation 108.

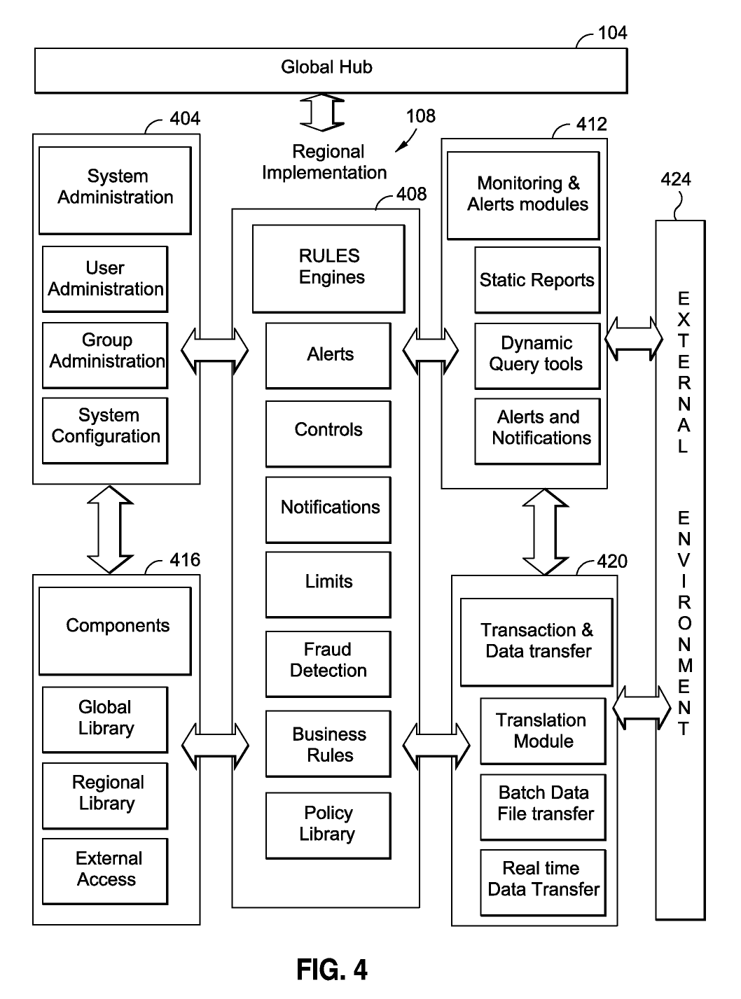

FIG. 4 provides an internal view of a regional implementation 108. As can be seen, the regional implementation 108 may be composed of several groupings of functionality. As stated above, this functionality may be implemented via hardware devices, such as computing devices or computers executing machine readable code or instructions configured to provide such functionality. In one embodiment, a regional implementation 108 may include the following functionality:

1. System Administration Functions 404

2. Rules Engines 408

3. Monitoring & Alerts Modules 412

4. Components (Libraries and Framework) 416

5. Transaction & Data Transfer Functions 420

The system administration functions 404 allow for the successful customization, configuration, and ongoing operations of the regional implementation 108. These functions set up and manage the parameters by which the other functions may be enabled, disabled, or modified. Typical functions in this group may include:

1. User Administration

2. Group Administration

3. System Configuration

The rules engine(s) 408 may control various interactions between internal functions as well as external interactions such as transaction authorization, alerts, reports, account enable/disable, limit adjustment, etc. Typical functions in this group may include:

1. Alerts

2. Notifications

3. Controls

4. Limits

5. Fraud Detection

6. Business Rules

7. Policy Library

The monitoring and alerts modules 412 house the ongoing reporting and analysis functionality. This is also where the parameters for the number of the Rules Engines functions are set and appropriate action enabled when triggering events occur. Typical functions in this group may include:

1. Static Reports

2. Dynamic Query Tools

3. Alerts & Notifications

The components 416 provide for the standard capabilities provided as part of the core of the regional implementation 108 as well as the framework for custom development and deployment within the regional implementation 108 as well as interaction with external interfaces directly or through third parties. Typical functions in this group may include:

1. Global Library

2. Regional Library

3. External Access

The transaction and data transfer functions 420 provide for the direct interaction between external systems 424 to support both real time and batch transfers of data. Such external systems may include end user systems/devices, value exchange environment systems, or both as described above with regard to FIG. 3. Typical functions in this group may include:

1. Translation Module

2. Batch Data File Transfer

3. Real Time Data Transfer

Within the components 416 are housed one or more libraries and frameworks for delivering capabilities to the various end users of the system. A global library may house common capabilities available to all regional implementations 108. Components envisioned to be contained in the global library may include:

1. Mobile Banking

2. Transfer Funds

3. Pending Payments (Described in greater detail below).

4. Top Up

5. mCommunication

6. Donate

7. Refer

8. Links

9. Sender/Consumer Controls (The Consumer (or Sender in the case of Transfers) may establish rules unique to the monetary account. This is distinct from traditional Corporate Purchase cards/account where an employer sets the limitations, a Family Card where a parent or master account holder sets the limits for secondary or subordinate cards, or traditional accounts whose limits are set by the Issuer either directly or indirectly. All of these may or may not apply but this particular functionality allows for additional controls to be placed in the hands of the cardholder themselves. This control may be used to reduce risk, adhere to a spending budget, or any number of reasons. These controls may include frequency or velocity of value measured in numerous increments of time (Hourly, Day portion such as “Evening”, Daily, Weekly, Monthly, Quarterly etc). Controls may set minimums, maximums, or even conditional limitations defined by rules. The controls may also be assigned by channels such as Point-Of-Sale (POS), ATM, card/account to bank transfer, TopUp, PendingPayments, TransferFunds (across different scenarios such as Person to Person-Domestic, Person to Person-International, internal accounts, etc), or even in aggregate. In conjunction with Receiver Controls, and the interoperability of the platforms, this allows for maximum choice and control for the Consumer).

10. Receiver Controls (The Receiver (who may also be a Consumer, Merchant, Bank, Agency, Biller, Telecommunications Operator, or similar entity) may establish rules unique to the monetary account. This is distinct from traditional accounts whose limits are set by the Issuer either directly or indirectly. All of these may or may not apply but this particular functionality allows for additional controls to be placed in the hands of the Receiver themselves. This control may be used to reduce risk or liability, control/preserve liquidity and value exchange (in the case of non-monetary related transfers), or any number of reasons. These controls may include frequency or velocity of value measured in numerous increments of time (Hourly, Day portion such as “Evening”, Daily, Weekly, Monthly, Quarterly etc). Controls may set minimums, maximums, or even conditional limitations defined by rules. The controls may also be assigned by channels such as Point-Of-Sale (POS), load network (by each specific network), bank to card/account transfer, TopUp, PendingPayments, TransferFunds (across different scenarios such as Person to Person-Domestic, Person to Person-International, internal accounts, etc), or even in aggregate. In conjunction with Sender/Consumer Controls, and the interoperability of the platforms, this allows for maximum choice and control for the Receiver).

11. mRewards

12. mTravel

To further extend the value of the regional implementation 108, a regional library that allows for the creation and housing of custom functionality may be included in the components 416. These are likely to be highly specialized and local in their structure. Components 416 envisioned to be contained in the regional library may include:

1. Ticket/Fine Payment

2. Local Transit

3. eCoupon/Virtual Card

4. Rebates (i.e. VAT refunds, tourism incentives)

These libraries are supported by a framework that allows for various methods of direct access (where a connection via the transaction and data transfer functions 420 is not desired). This framework may include the following (for example):

1. Mobile 2 3rd Party Connect

2. System API framework

3. GUI Front End Library

4. Custom System Integration

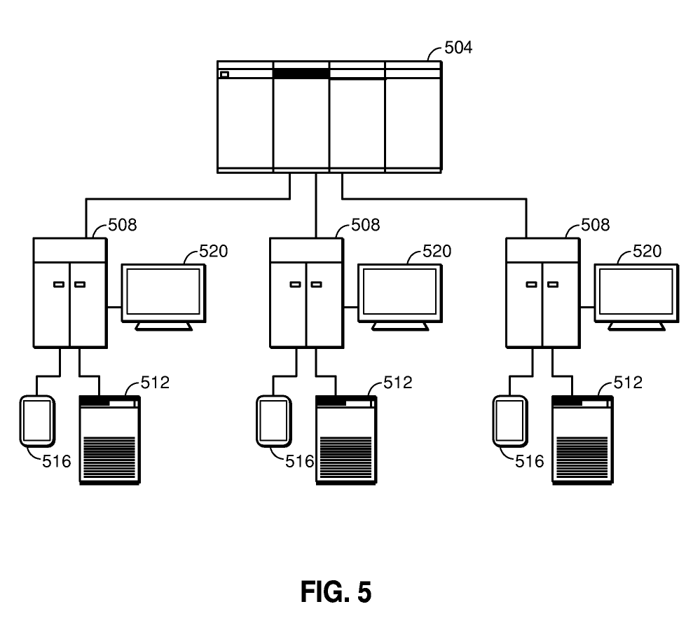

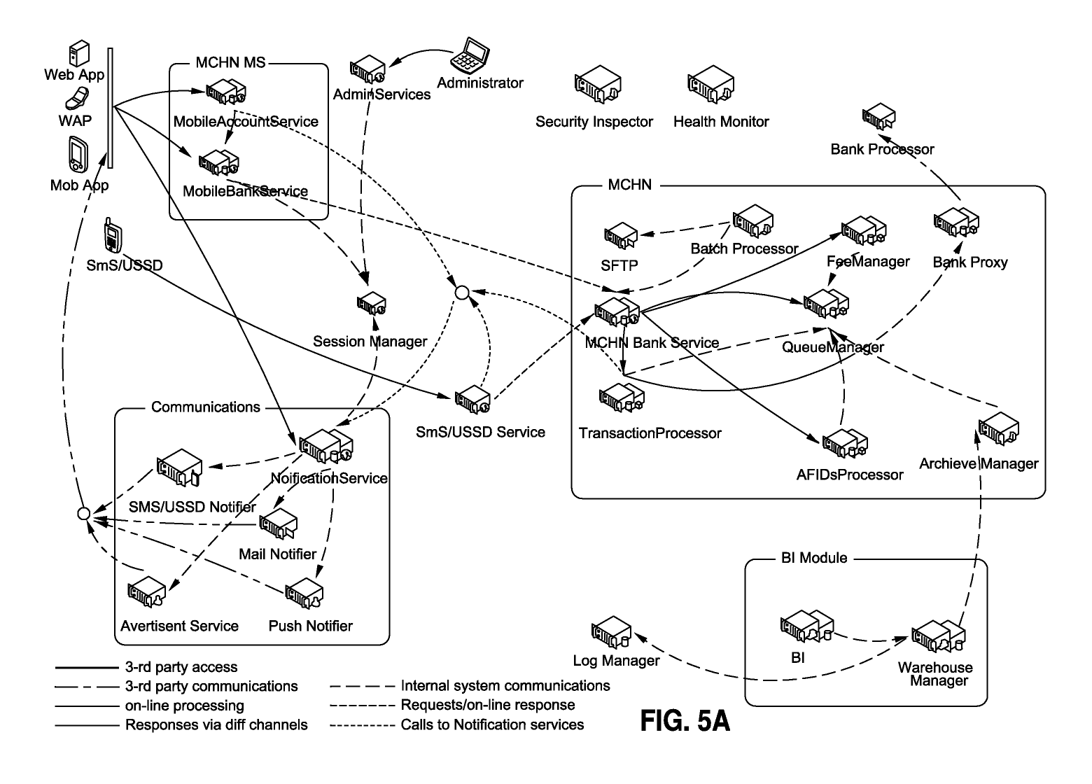

FIG. 5 is a block diagram illustrating various hardware of an exemplary embodiment of the clearinghouse system. As stated above, the clearinghouse system may comprise a global hub and one or more regional implementations in communication with various end users, regional administration, and value exchange environments. FIG. 5 shows an exemplary implementation of the clearinghouse system.

As can be seen, global hub functionality may be provided by one or more global hub servers 504. Likewise, regional implementations may be provided by one or more regional servers 508 in communication with a global hub server 504. It is noted that communication may occur through various communication links and protocols. Typically, the communication links, protocols, or both will be encrypted or otherwise secured to protect value exchange information.

Each regional server 508 may communicate with various value exchange environments and end users to facilitate, monitor, and/or control transactions, such as described above with regard to FIG. 3. As can be seen, the value exchange environments may be implemented by value exchange servers 512. End users may interact with regional servers 508 and value exchange servers 512 through one or more client devices 516, such as cell phones, smart phones, PDAs, tables, laptops or other mobile computing devices. It is contemplated that a client device 516 need not be mobile in all embodiments (e.g., a desktop computer or terminal). However, mobile client devices 516 provide the benefit of allowing a user to make transactions wherever they are. The regional servers 516 may accept communications from client devices 516 and value exchange servers 512 through various communication links and protocols, including encrypted or secured communication links and protocols.

The servers described above may comprise one or more processors, memory devices, and communication interfaces. The one or more processors may execute machine readable code stored on a memory device to provide the functionality of the global hub and regional implementation(s). The communication interfaces, such as network interfaces for example, may be used to communicate transaction and other information with other servers or devices. It is contemplated that in distributed environments, a plurality of servers may be used to provide global hub functionality or regional implementations. In addition, the servers may include or have access to remote memory or storage devices that may be used to store transaction information.

Regional administration (as discussed above with regard to FIG. 3) for a regional server 508 may be implemented by a regional administration terminal 520. The regional administration terminal 520 may comprise a display or other output device(s) and various input device(s), such as keyboards and/or mice. The input devices allow a user to control or configure the regional server 508, while the display or other output device provides feedback to the user's input. For example, a GUI may be presented to a user, and a user may select one or more operating modes for the server (e.g., monitor transaction or monitor and control transactions), define one or more transactions that are not permitted, or generate one or more reports regarding monitored transactions via the input and output devices of a regional administration terminal 520.

It is contemplated that the global hub server 504 may also have its own terminal for administration or control purposes. In addition, it is contemplated that a terminal may be a separate computing device (e.g., smart phone, PDA, tablet, or desktop or laptop computer) providing remote access to a global hub server 504 or regional server 108.

FIG. 5A is a diagram which illustrates a preferred embodiment of a clearinghouse system. As illustrated, the system includes a main clearinghouse (such as including devices and/or software which are configured to execute various transactions, including a Queue Manager, various transaction processors and the like), a BI Module (such as including devices and/or software which are configured to store or warehouse data such as transactional information), a main Communications Module (which may include various devices and/or software which are configured to manage messages, mail and the like, including communications with various client devices), a Mobile Account Manager (which may include various devices and/or software which are configured to implement various mobile services such as those described below), and various other devices and elements. For example, the clearinghouse may include a security inspection module, health monitor, administration module, session manager, messaging manager (such as a SMS/USSD manager), etc. Of course, the clearinghouse might comprise a wide variety of hardware and/or software elements and devices, in various combinations.

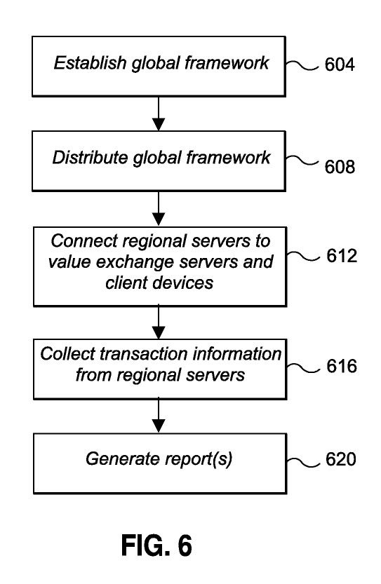

FIG. 6 is a flow diagram illustrating exemplary steps that may be followed to implement the clearinghouse system at one or more hardware devices, such as the servers described above. At a step 604, a global framework may be established or defined. As discussed above, the global framework may define standardized protocols for accepting transaction information, communicating transaction information, or both (among other things). By complying with the global framework, interoperability between various global hub servers and regional servers is ensured. In addition, value exchange servers as well as client devices may be configured according to the global framework to ensure their interoperability with the clearinghouse system. Alternatively, it is contemplated that regional servers may be configured to accept or convert transaction information between one or more formats used by client devices and value exchange servers and a format or protocol defined in the global framework.

Once established, the global framework may be distributed at a step 608. This may occur in various ways. For example, the global framework may be published electronically or on paper publications in human readable form or machine readable form, or both. In this manner, interested parties may view the global framework and implement it on their regional servers, client devices, or value exchange systems. It is contemplated that the global framework may comprise one or more data files defining various protocols or formats used by a clearinghouse system.

Regional servers, client devices, and value exchange servers may be configured to automatically read or download a global framework file and configure their communications or data formats accordingly. In this manner, human intervention is reduced if not eliminated in such embodiments. The global framework may be retrieved by regional servers or other devices from a global hub in some embodiments. It is contemplated that a global hub may instruct regional servers or other devices to retrieve or update themselves with a new or modified global framework in some embodiments. In this manner, the global hub may serve to control distribution of the global framework to other parts of the clearinghouse system.

Once at least the regional servers are configured according to the global framework, the clearinghouse system may begin operation. It is noted that client devices and value exchange servers may also, but need not, be configured according to the global framework since (as discussed above) the regional servers may be capable of accepting and/or translating a wide variety of data formats and protocols.

At a step 612, regional servers may be connected to one or more value exchange servers. This may occur in various ways. For example, in one embodiment a physical connection may be made between a regional server and value exchange server, such as via a network or other communication cable. A wireless connection may also or alternatively be made. In other embodiments, connection may occur by configuring the regional server and value exchange server to communicate transaction information with one another. For example, a user may identify a network address, name, or other identifier of a regional server to a value exchange server, and vice versa in order to cause transaction information to be communicated there between. It is contemplated that authentication or authorization information may need to be shared or passed between the value exchange server and regional server to establish a connection.

The regional server may also be connected to one or more client devices in similar manner. This connection may occur at step 612 as well. It is contemplated that client devices may connect at various other times since their operation is governed by their use by individual users. For example, a client device may connect to a regional server when a transaction is about to be made or is pending.

Once connections are made, the regional server may begin monitoring, facilitating, and/or controlling one or more value exchange transactions between end users/client devices and value exchange servers. Regional servers may store this information on one or more local storage devices or on remotely accessible storage devices, such as hard drives, flash drives, removable media, or the like.

At a step 616, information from regional servers may be collected by or sent to a global hub server. The regional servers may format data according to a global framework for communication with the global hub server. This ensures the global hub server can understand information from the regional servers. This is advantageous since regional servers may be configured to collect or monitor various types of transaction information for a wide variety of value exchange types (as discussed above). To illustrate, the global framework may identify a set of data that the global hub server will accept from regional servers. The regional servers may then send only this data to the global hub server even though each regional server may be collecting a variety of other data, such as to meet regulatory requirements within their respective regions.

The global hub server may store the information one or more storage devices local or remotely accessible from the global hub server. Users may then generate one or more reports from the transaction information at a step 620. Analysis may then be performed on the transaction information. In one or more embodiments, the transaction information may be stored in one or more categories or fields so as to allow the information to be easily manipulated. For example, one or more calculations may be performed on particular fields of the transaction information, or particular fields of the transaction information may be aggregated to produce a report. Policy or regulatory decisions/changes may then be made based on the transaction information.

As discussed above, in the payments space, there are a multitude of consumer payment methods for goods and services as well as a multitude of channels by which the consumer can access those payment methods. The same is true for the overall space of the transfer of monetary value between entities. The vast majority these options can be grouped into a handful of categories:

1. Peer-To-Peer: These are typically consumer to consumer transfers of monetary value within a country or region (Domestic C2C).

2. Merchant Payments: These are real time or on demand Consumer to Business (C2B).

3. Cross-Border Money Transfer: These are typically consumer to consumer transfers of monetary value (Cross Border C2C).

4. Billing Payment and Presentment: Consumer to Business (C2B) or Business to Business (B2B).

A number of the current options available to consumers exist across a variety of channels including but not limited to the Internet (via fixed or mobile personal computers, smart phones, PDAs, tablets, or devices), voice based channels such as Interactive Voice Response systems accessed via landlines, wireless or cellular phones, or personal computer based voice communications (VOIP), or proprietary/closed systems which may or may not use magnetic stripe or EMV/Chip based methods, dedicated POS/ATM devices, and standards (such as the ISO8385 specification).

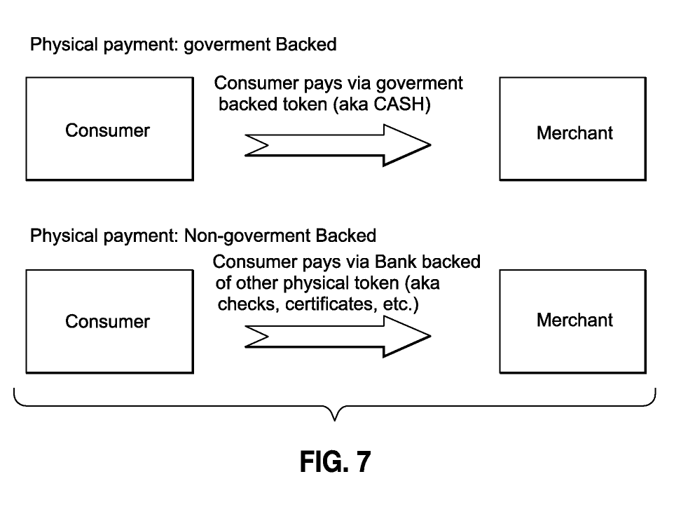

The wide variety of options has given rise to a decreased efficiency of the payments mechanisms as well as a burden of choice for the consumer. Physical solutions, such as shown in FIG. 7, have become limited to traditional payments schemes (such as MasterCard and Visa) due to the need for and cost of deployed, dedicated devices integrated into merchant operations. Personal computer based solutions have allowed for more cost effective payment alternatives to the traditional schemes but have been largely constrained to online orders or bill payment functionality. A gap still persists at the point of sale between easy to use, portable, payment alternatives to the traditional card based systems and the personalized, lower cost, payment methods emerging in the online space. In addition, as shown by FIG. 7, current processes bear the costs of including these various participants and creating relationships between them to facilitate payment or value exchange transactions.

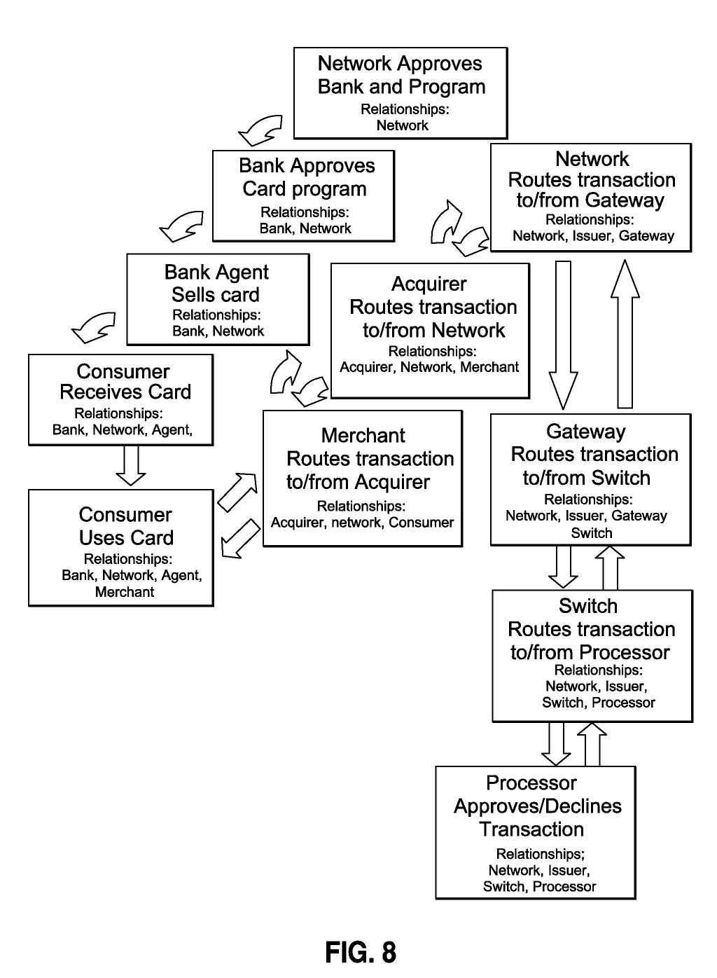

A pending payments system is disclosed herein to bypass the traditional methods for payments authorization by allowing for a direct request to be passed from the merchant to the consumer for authorization. As can be readily seen from the traditional payments system structure illustrated in FIG. 8, this direct relationship is to precluded by complex issuing, transaction switching, processing, and settlement structures. The relationship barrier continues to get bigger as payment schemes find new ways to make themselves a mandatory part of the process at the expense of the merchant. The most direct relationship the consumer can have with the merchant is via cash, but this is also expensive (for the ecosystem) and risky (for the consumer and merchant alike). A high degree of cash volume also poses a control risk to agencies and regulatory bodies due to little traceability.

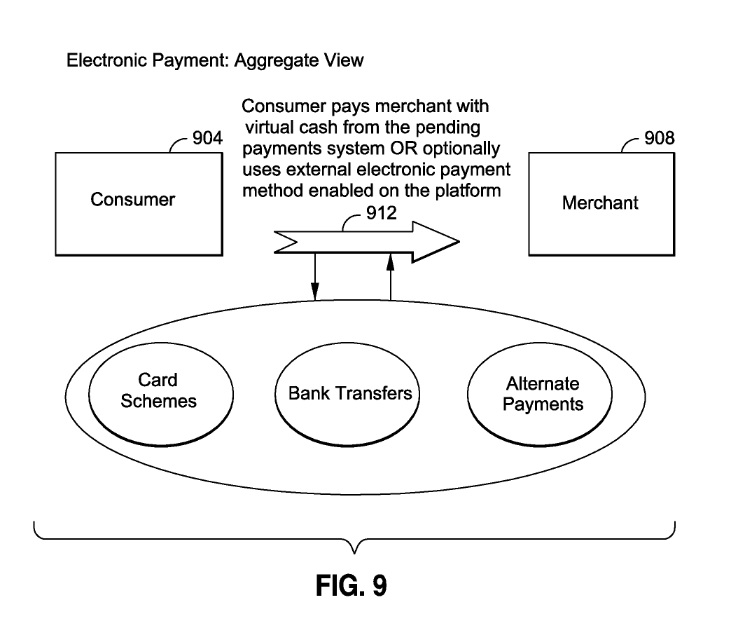

Referring to FIG. 9, the pending payments system of the invention provides a more direct connection from a consumer 904 to a merchant 908 without the risks, costs, and issues posed by cash, without the costs and exclusivity required by traditional payment schemes, and while allowing for traceability and controls. In order to maximize value, the pending payments system may also need to be compatible with existing (and possibly emerging) payment methods and technologies. As such, the pending payments system will also provide for interoperability with other payments services through their various methods, as will be described below.

As can be seen from FIG. 9, the pending payments system may operate to facilitate a direct transaction 912 between a consumer 904 and a merchant 908. Unlike traditional physical payment systems, such as those shown in FIG. 7, the pending payment system allows a consumer to effect payment with various items of value, including but not limited to currency. For example, a consumer may pay with alternative payment forms, such as virtual cash, or other items of value such as prepaid cards, or phone minutes (as described above). Alternatively, the pending payment system also allows electronic payments of currency to be made, such as via funds transfers from banks, credit cards or the like. The direct nature of the pending payment system may virtually remove bad debt in the mobile commerce world as well as retail locations.

As shown, the pending payment system allows direct transactions 912 between a merchant and consumer that utilizes various forms of value exchange. For instance, in FIG. 9, card schemes, bank transfers, and alternate payments are shown as ways for transferring value from a consumer to a merchant. The pending payment system may allow a consumer 904 to setup various payment methods and allow a consumer to select these methods when making a purchase. For example, the consumer 904 may input bank account information, credit card information, prepaid card information and the like into the pending payment system. When making a purchase with the pending payment system, the consumer 904 may be presented with these options and be allowed to select one or more of them through which to make payment. It is contemplated that the consumer 904 may also setup other payment methods. For example, it may be possible to use cell phone minutes to purchase goods or services from merchants 908. The consumer 904 may, in such situations, setup his or her cellular carrier account with the pending payment system, such as by entering the cellular carrier account information and any required authorization information. Payment may then be made with cell phone minutes by deducting a number of minutes from the user and transferring them to the merchant, by transferring a monetary value for the minutes to the merchant, or by charging the payment amount to the consumer's cellular phone account.

It can thus be seen that the pending payment system allows a various items of value to be used to pay a merchant 908. Payment may be immediately settled with the merchant 908 by transferring the value to the merchant's account. Alternatively, payment may be settled at one or more predetermined times. It can also be seen that the pending payment system provides a direct transaction 912 between the consumer 904 and merchant 908.

As long as the merchant 908 and consumer 904 both utilize the pending payment system, various forms of value may be directly transferred from the consumer to the merchant to effectuate payment. This includes forms of value not otherwise accepted by merchants at point of sale locations. For example, a consumer 904 may pay a merchant 908 by transferring funds directly from the consumer's checking, savings, or other bank account using the pending payment system. In addition, a consumer 904 may pay using prepaid value cards via the pending payment system. Also, it is contemplated that various payment types may be combined. For example, a percentage or portion of a payment may be transferred from a consumer's bank account while the remainder may be paid from other payment methods, such as a prepaid value card, credit card, or cellular phone account. It is contemplated that the percentage or portion may be defined or set by a user for the current transaction or for multiple transactions.

Typically, the payment from a consumer 904 will be directly transferred to a merchant by the pending payment system. This greatly reduces, if not eliminates, unnecessary costs in transferring payment from the consumer to the merchant. In this manner, the pending payment system functions as virtual cash in that it allows direct transfer of value in an extremely efficient manner. It is noted that in some situations payment may first be transferred to the pending payment system before transferring the payment to the merchant 908. In one or more embodiments, the pending payment system may confirm that the user has sufficient available funds before allowing a payment transaction to occur. In one embodiment, a consumer 904 may not be allowed to accept a transaction without first having sufficient available funds or the consumer may do so conditionally while being prompted to add funds needed to complete the transaction.

The pending payment system may utilize merchant point of sale devices and consumer client devices during operation. These devices may be configured according to a standard, such as the global framework discussed above. The standard or framework may be defined in various ways. In one embodiment for example, the standard may be defined via an API which merchants and consumers may utilize to make payments via the pending payment system.

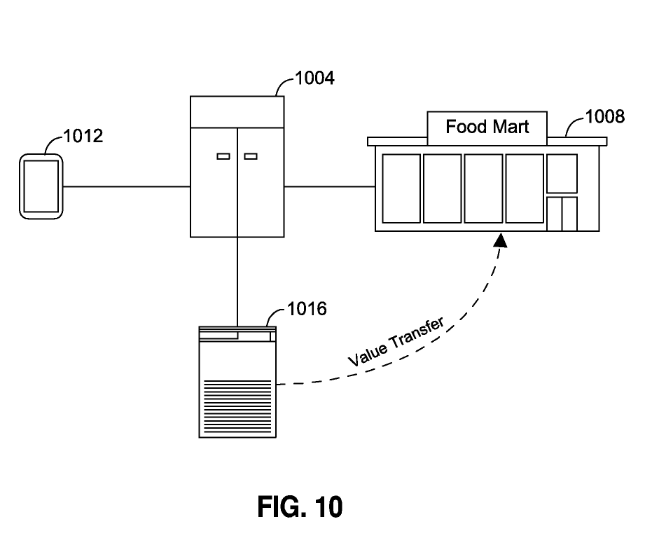

FIG. 10 illustrates an exemplary pending payment system. As can be seen, the pending payment system may comprise one or more pending payment servers 1004. It is noted that the pending payment system may be a standalone system or may be integrated into a global hub system such as those described above. For instance, referring to FIG. 3, a pending payment system may be one of multiple payment schemes within a value exchange environment. A regional implementation 108 may then facilitate, monitor, and/or control transactions between the pending payment system and one or more end users 316. Such a global hub system may be implemented by a regional server 508 in communication with a value exchange server 512 (configured as a pending payment server) and one or more client devices 516 (configured as payment devices), such as shown in FIG. 5.

The pending payment servers 1004 may be configured to communicate with one or more merchant systems and client systems of consumers. For example, a point of sale device 1008 and client device 1012 (e.g., cell phone, smart phone, PDA, tablet, etc. . . . ) may communicate with a pending payment server 1004 via various communication links. As will be described below, client devices 1012 and point of sale devices 1008 or other merchant systems may initiate transactions for the exchange of value between a consumer and a merchant. For example, as shown, the pending payment server 1004 may instruct a financial institution's server 1016 to initiate a value transfer (e.g., payment) to a merchant's point of sale device 1008 to complete a payment.

It is noted that (though not shown in FIG. 10) a client device 1012 may communicate directly with a point of sale device 1008 in some embodiments. For example, the client device 1012 may communicate account information and/or identification information that the point of sale device 1008 may use to charge a user's account. The point of sale device 1008 may then communicate a payment request to the payment server 1004 to receive payment.

As discussed above, a pending payment server 1004 may comprise one or more processors and memory devices. The memory devices may store machine readable code that provide the pending payment server functionality disclosed herein.

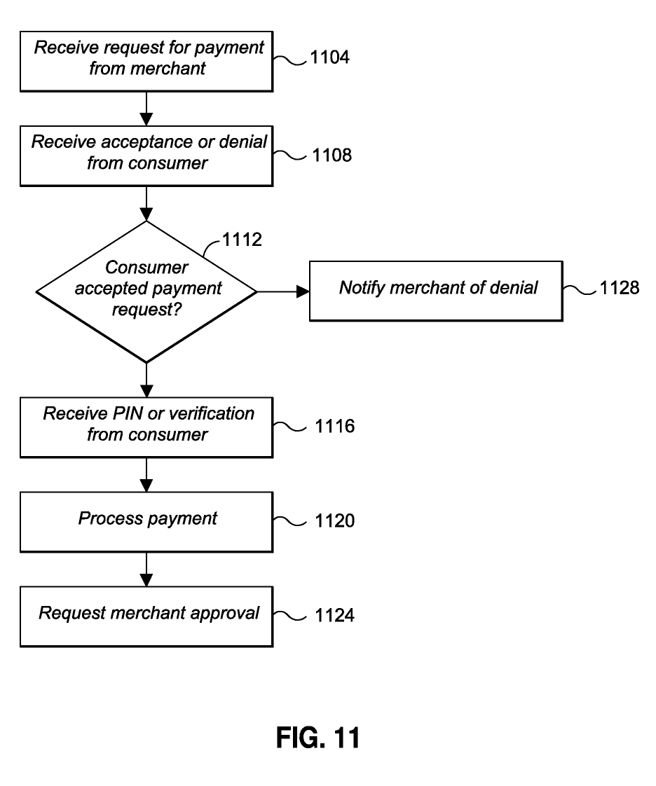

Operation of the pending payment system will now be described with regard to the flow diagram of FIG. 11. FIG. 11 illustrates a merchant initiated transaction requesting payment from a consumer. At a step 1104 a merchant may submit the transaction into a pending payment job queue via one or more predefined APIs of the pending payment system. The consumer may be automatically notified of a merchant's request for payment as a result. The consumer may then open his or her pending payments queue via a client device, such as a cell phone, smart phone, PDA, tablet, laptop, or other computing device. The consumer may select the appropriate pending payment and accept or deny the transaction at a step 1108. The consumer's acceptance or denial of the transaction may be reported to the pending payment system or server.

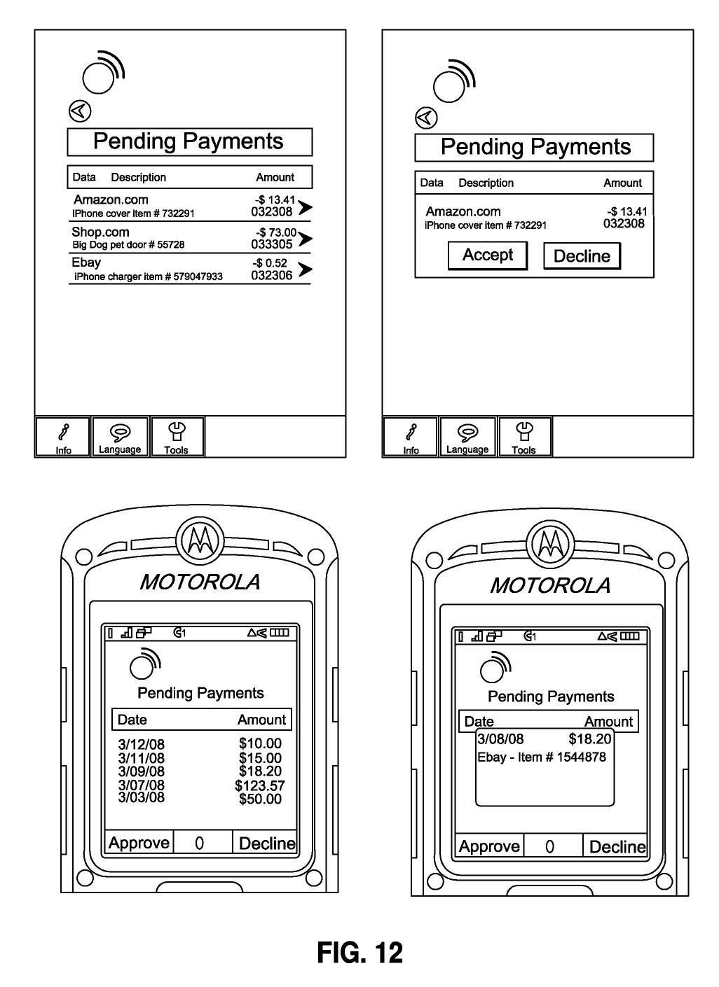

Referring to FIG. 12, it can be seen that the consumer may be presented with a GUI including one or more pending payment transactions and providing one or more controls to allow a user to select and/or accept or deny these transactions individually as desired. As can be seen, the merchant to be paid or requesting payment may also be displayed along with the amount of the payment transaction.

Referring back to FIG. 11, at a decision step 1112, if a consumer accepts the transaction they will be prompted to enter their PIN at a step 1116. The order may then be processed by the pending payment server at a step 1120, and submitted to the merchant for approval at a step 1124. The pending payment server may then settle merchant funds at the end of the night to the merchant's bank account. If the consumer denies the transaction at decision step 1112, the merchant may be notified that the transaction has been denied at a step 1128. The transaction will then be cancelled and will not occur.

The following example helps illustrate how a payment may be made using the pending payment system:

1. Customer checks out at cashier.

2. Customer states they want to use the pending payment system as their payment method.

3. Cashier chooses the pending payment system as the payment method which triggers the grocery store's processing systems to use the pending payment system's APIs to process the transaction.

4. Customer approval process then takes place as discussed above.

In another example, an online e-commerce merchant may accept payment using the pending payment system as follows:

1. Customer makes an online purchase.

2. Customer selects the pending payment system as their payment method.

3. Merchant then sends the transactional information to the pending payment system via its Pending Payments APIs and instructs the customer to approve the transaction on their mobile device.

4. Customer approves transaction and the approval and any requested information is then sent back to merchant to finalize the transaction.

As can be seen, this process makes buying goods and services online completely secure and extremely fast. This process eliminates customers having to enter all their customer and payment information. Customers can now literally buy something online in less than a minute and in a secure manner.

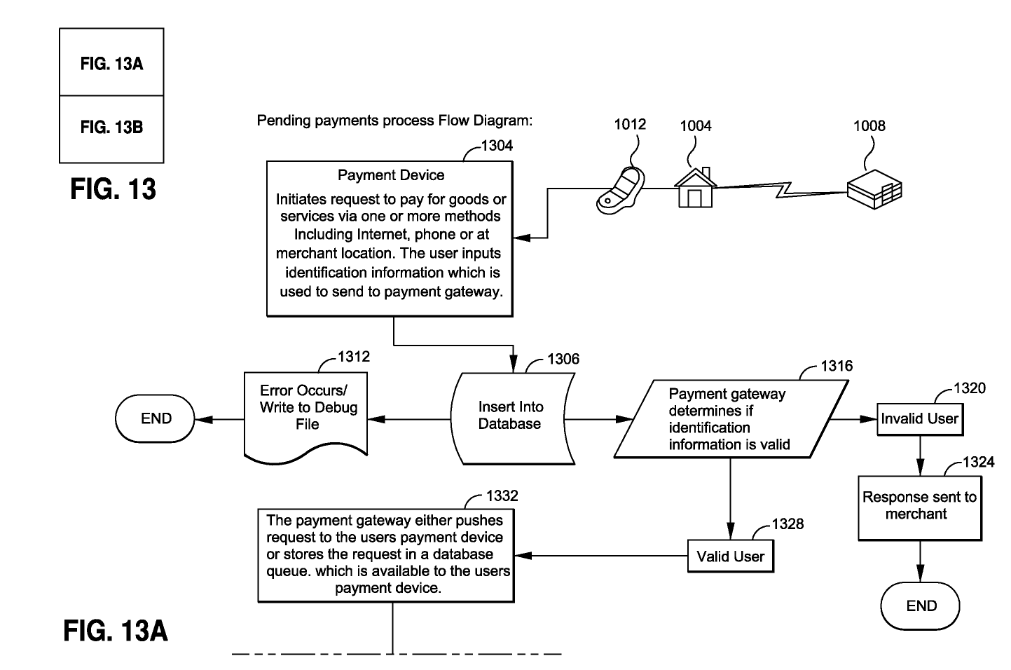

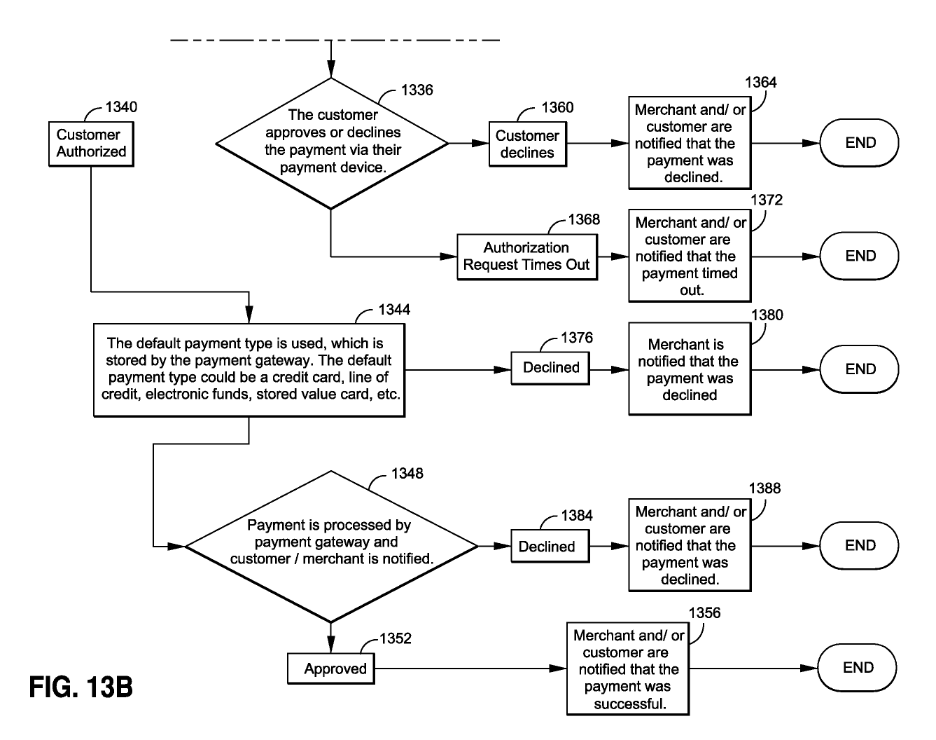

FIG. 13 is a flow diagram illustrating various details regarding the operation of the pending payment system. In FIG. 13, the payment transaction has been initiated by a consumer via a client device 1012. It is also possible for a merchant system or point of sale device 1008 to initiate the payment transaction, as discussed above with regard to FIG. 11.

At a step 1304, a payment device, such as a client device 1012 may initiate a request to pay for goods or services using the pending payment system. It is noted that the payment device may be a point of sale device 1008 or other merchant device as well. At a step 1306 the request may be inserted into a database accessible by one or more pending payment systems servers. If an error occurs at a step 1312, the payment transaction may end. One or more administrators may be notified of this failure so that any necessary repairs may be made.

If the database entry succeeds, at a step 1316, a payment gateway may verify if user identification information is valid. For example, a user's username and password may be verified or other identifying information may be verified to ensure that a valid user is using the system and that the user is who the user says he or she is. If the user is determined to be invalid at a step 1320, a notification of the same may be sent to the merchant at a step 1324. It is noted that the payment gateway may be one of the pending payment servers (or other computing device) or may be implemented by a pending payment server, such as by executing machine readable code to provide the functions of the payment gateway.

If the user is a valid user at a step 1328, then payment processing may continue. At a step 1332, the payment gateway may send or forward the request to a payment device 1012. Alternatively, the payment gateway may store the request in a database queue so that it is accessible by the payment device 1012. It is contemplated that a notification may be sent to the payment device 1012 to inform a consumer that a new pending payment transaction has been added to his or her pending payments queue.

The consumer may view pending payments on the payment device 1012 after step 1332. For example, pending payments may be displayed on a user's cell phone or smart phone after step 1332. At a step 1336 the consumer may accept or decline a pending payment transaction, such as described above with regard to FIG. 12. If the consumer declines at a step 1360, then the merchant and/or consumer may be notified of the same at a step 1364. The payment process may then end.

It is contemplated that the request may timeout at a step 1368 if the consumer fails to accept or decline a payment transaction within a predefined time. At a step 1380, the merchant may be notified when this occurs. This feature is beneficial in that it ensures that payments are made in a timely manner when required. For example, a merchant may desire immediate payment or define a limited time for payment for particular types of goods or services. Payment processing may then end.

If the consumer accepts or authorizes the transaction at a step 1340, then a default payment type may be used to effectuate the payment at a step 1344. For example, the default payment type could be a credit card, line of credit, electronic funds transfer, stored value card, etc. . . . It is noted that the consumer may define and redefine the default payment type at any time. In addition, the default payment type may include funds (or other items of value) from multiple accounts or other sources of value.

As disclosed above with regard to FIG. 9, the pending payment system allows a consumer to use and a merchant to accept various payment types to make a purchase. Thus, at step 1344 the consumer may be provided with an option to select one or more of various sources of funds or value from which the consumer will make payment to the merchant. As described above, one or more of these payment options may not be otherwise acceptable by a merchant. For example, a merchant may be limited to accepting only cash and credit cards via a preexisting point of sale system. By utilizing the pending payment system, the merchant may accept payment types beyond these. For example, the merchant may use the pending payment system to accept payment via electronic funds transfer (e.g., wire transfer or direct deposit), prepaid cards, or cell phone accounts at its point of sale devices.

At a step 1348, the payment may be processed by the payment gateway and the consumer and/or merchant may be notified of the status of the payment (e.g., in processing). If the payment is declined at a step 1384, the merchant and/or consumer may be notified that the payment was declined at a step 1388. Payment processing may then end. If the payment is approved at a step 1352, the merchant and/or consumer may be notified that the payment has been successful at a step 1356. Payment processing may then end. As can be seen, the pending payment system provides a more direct relationship between buyer and seller, lower total cost to the system, benefits of electronic transactions, and extended reach to new consumers, new markets.

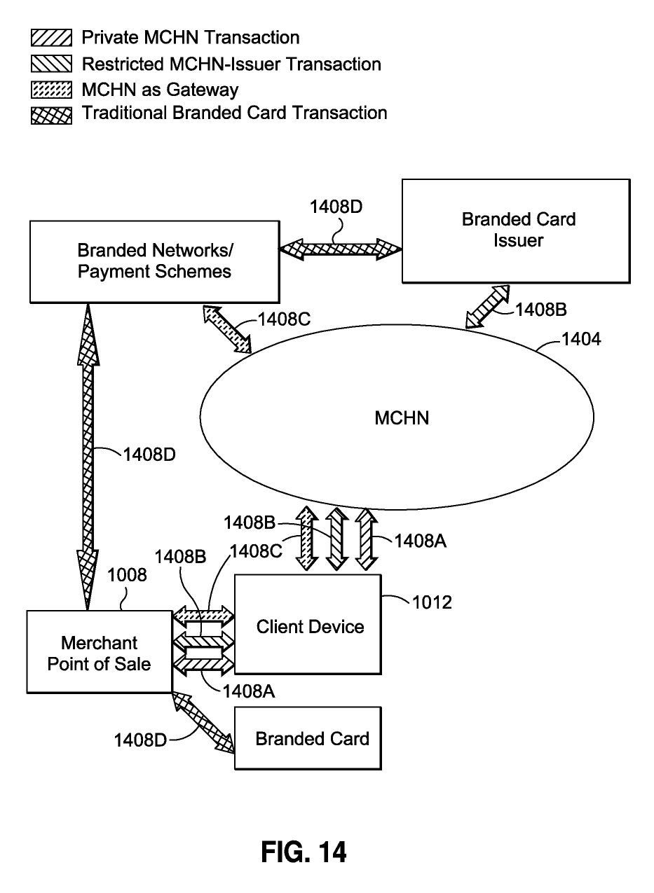

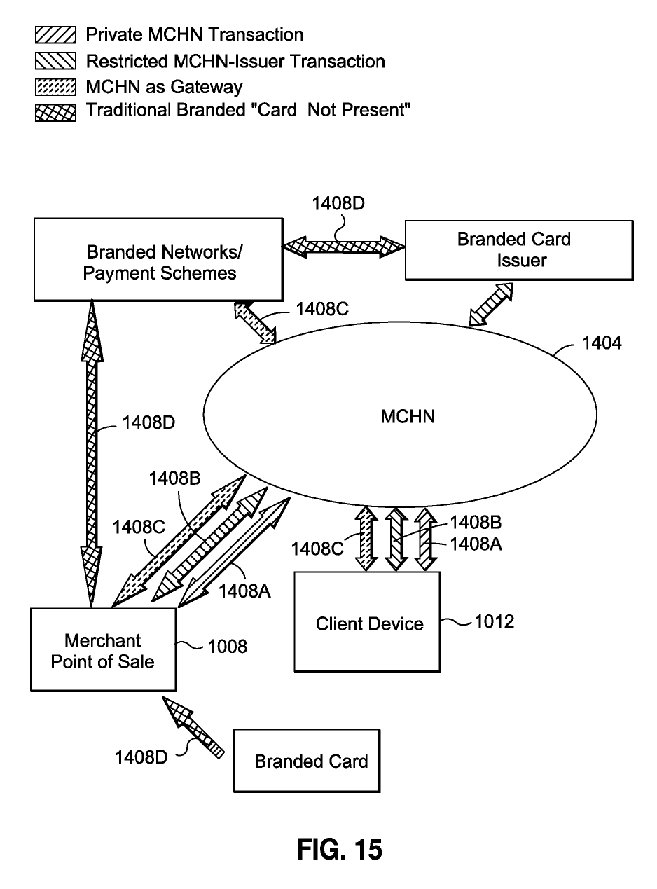

FIGS. 14-15 provide high level functional diagrams of one embodiment of a pending payment system. As can be seen, a mobile clearinghouse network (MCHN) 1404 may be provided. The MCHN 1404 may comprise one or more pending payment servers in one or more embodiments. The MCHN 1404 may take part in, facilitate, monitor, and/or control various transaction types. FIGS. 14-15 illustrate four exemplary transaction types. Namely, private MCHN transactions 1408A, restricted MCHN-Issuer transactions 1408B, gateway transactions 1408C, and traditional branded transactions 1408D.

In FIG. 14, the MCHN 1404 is shown effectuating various physical (i.e., brick and mortar) transactions. In FIG. 15, the MCHN is shown effectuating various online transactions. As can be seen from the figures, the MCHN 1404 may function as a payment gateway in one or more embodiments. In other words, the MCHN 1404 may serve as a conduit or intermediate transfer area for funds or other value flowing from a consumer to a merchant.

As can also be seen, the MCHN 1404 may be limited or configured to engage in only particular transactions with particular financial entities. For example, as shown, the MCHN 1404 takes part only in gateway transactions 1408C with Branded Networks/Payment Schemes, while only restricted MCHN-Issuer transactions 1408B occur between the MCHN and Branded Card Issuers in the embodiments of FIGS. 14-15.

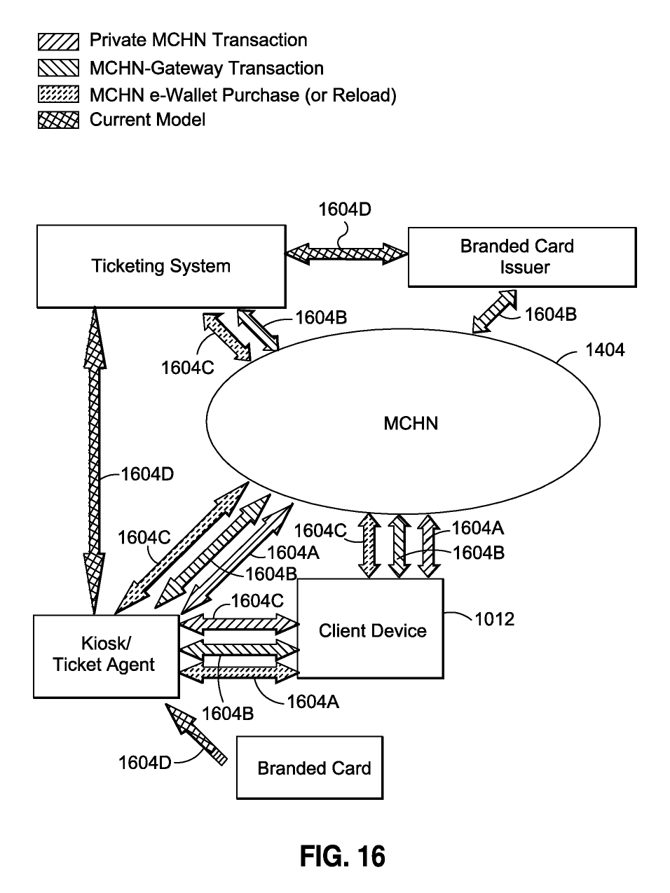

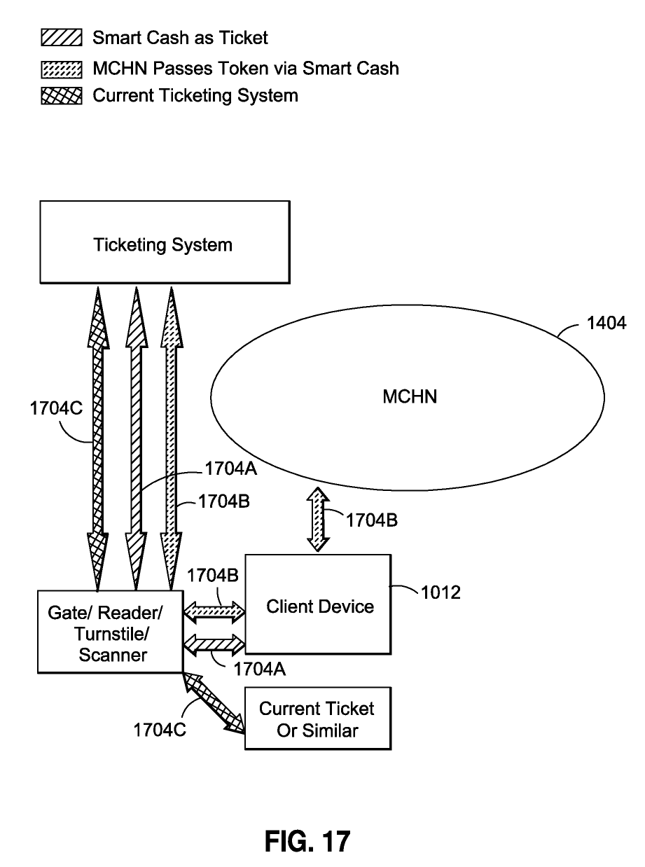

FIGS. 16-17 illustrate an MCHN 1404 effectuating value transfer in the environment of transportation tickets (e.g., airline, train, or other tickets for travel). FIG. 16 illustrates transactions that may be facilitated, monitored, and/or controlled by the MCHN 1404 during a ticket purchase. As can be seen, four transaction types are shown, namely, private MCHN transactions 1604A, MCHN-Gateway transactions 1604B, MCHN e-Wallet purchases (or reloads) 1604C, and traditional transactions 1604D. As can also be seen, the MCHN 1404 may function as an alternative to traditional branded card transactions, which limit consumer choice to a few predominant card types. FIG. 17 illustrates the transactions facilitated, monitored, and/or controlled by the MCHN during a ticket redemption. FIG. 17 shows three transaction types, namely, transactions using monetary value as a ticket 1704A, transactions using non-monetary value (e.g., a redeemable token) 1704B, and traditional ticket redemption transactions 1704C.

Referring to FIGS. 14-16, it can be seen that a client device 1012 may be used to make purchases much like a traditional branded card (e.g., credit card, prepaid card, ATM card). As discussed the client device 1012 may communicate or cooperate with the MCHN 1404 (or pending payment server) to cause monetary value to be transferred from a consumer to a merchant. Using the client device 1012 may trigger one or more transactions, as shown in the figures, to complete this value transfer.

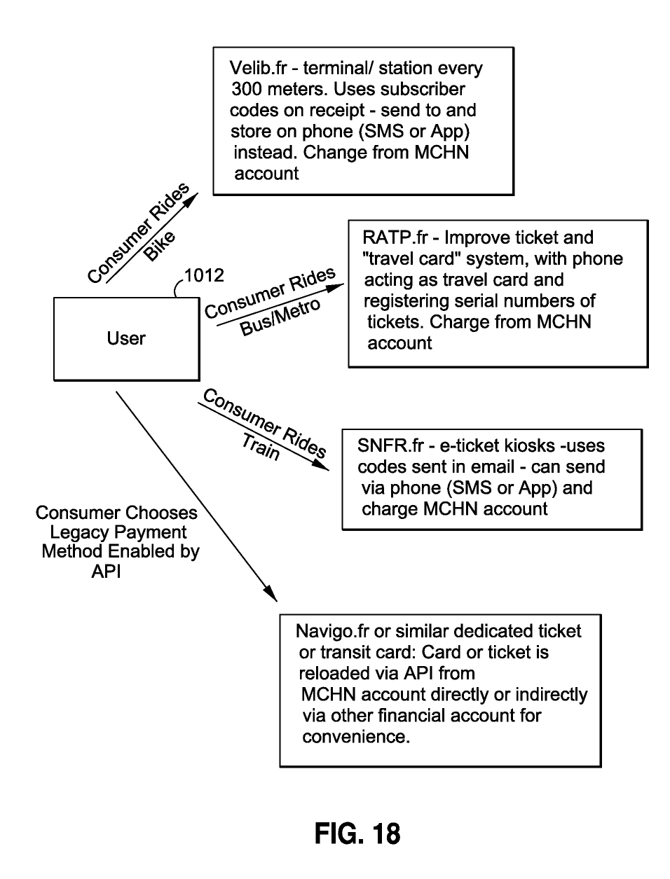

Referring to FIG. 17, it can be seen, that the client device 1012 and MCHN 1404 may also be used to transfer non-monetary value. In the example of FIG. 17, it can be seen that the client device 1012 may be used as a transportation ticket or token. This allows the value of the ticket/token to be exchanged for transportation services, such as bus, train, or airline travel. FIG. 18 is a block diagram showing that the client device 1012 and MCHN/pending payment system may be used for a variety of monetary and non-monetary value transfer. Though shown in a transportation environment, it is noted that the client device 1012 may be used in other ticketing systems/environments (e.g., show tickets, movie tickets).

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A clearinghouse system comprising:
a global hub;
one or more regional servers in communication with one or more value exchange servers, the one or more regional servers configured to monitor transactions involving transfers of value via the one or more value exchange servers and to report the transactions to the global hub; and
a global framework defining data formats for communication between at least the global hub and the one or more regional servers, the global framework stored on a storage device accessible to the one or more regional servers.

2. The clearinghouse system in accordance with claim 1 wherein said global hub comprises a plurality of distributed nodes.

3. The clearinghouse system in accordance with claim 2 wherein said plurality of distributed nodes comprise global hub node servers and wherein each regional server has at least one associated global hub node server.

4. The clearinghouse system in accordance with claim 3 wherein said global framework is stored on said global hub node servers.

5. The clearinghouse system in accordance with claim 1 wherein said global framework further defines a plurality of rules which is implemented by said one or more regional servers.

6. The clearinghouse system in accordance with claim 1 wherein said one or more regional servers monitor exchanges of non-monetary value via said one or more value exchange servers.

7. The clearinghouse system in accordance with claim 6 wherein said non-monetary value is selected from the group consisting of: points, miles and minutes.

8. The clearinghouse system in accordance with claim 1 wherein said transfers of value occur between a merchant and a consumer.

9. The clearinghouse system in accordance with claim 1 wherein said one or more value exchange servers monitor exchanges of monetary value via said one or more value exchange servers.

10. The clearinghouse system in accordance with claim 9 wherein said exchange of monetary value occurs between a merchant and a consumer via value exchange environment.

11. The clearinghouse system in accordance with claim 10 wherein said value exchange environment comprises a bank.

12. A clearinghouse system comprising:
a pending payment server configured to communicate with at least one consumer payment device and at least one merchant payment device, the pending payment server configured to receive a request for payment from the consumer and merchant payment devices and to receive an acceptance or denial of the request for payment from the consumer payment device;
an application programming interface implemented on the pending payment server, the application programming interface configured to define the data format for communication with the pending payment server; and
one or more communication links between the pending payment server and one or more value exchange servers that are not available on the merchant payment device, wherein the pending payment server is configured to instruct the one or more value exchange servers to transfer monetary value to one or more merchants through the one or more communication links.

13. The clearinghouse system in accordance with claim 12 wherein said at least one consumer payment device comprises a mobile device having a wireless communication interface.

14. The clearinghouse system in accordance with claim 12 wherein said acceptance comprises input of a code by the consumer.

15. The clearinghouse system in accordance with claim 12 wherein said pending payment server is configured to transmit a request to the consumer payment device for approval by the consumer in response to a request for payment from at least one merchant payment device.

16. A global clearinghouse system comprising:
a global hub comprising at least one global hub node server; and
a plurality of regional servers, each regional server associated with a region and in communication with the at least one global hub node server, and each regional server in communication with one or more associated value exchange servers, each regional server configured to monitor transactions involving transfers of value via the one or more value exchange servers associated therewith and to report the transactions to the global hub, and wherein said regional servers effect transactions between regions;
wherein said global hub is configured to implement a plurality of global rules applicable to all of said plurality of regional servers relative to transactions between regions and wherein each regional server is configured to execute particular regional rules relative to transfers via said one or more value exchange servers associated therewith.

17. The global clearinghouse system in accordance with claim 16 wherein transfers of value occur between a merchant and a consumer.

18. The clearinghouse system in accordance with claim 16 wherein said one or more value exchange servers monitor exchanges of monetary value via said one or more value exchange servers.

19. The clearinghouse system in accordance with claim 18 wherein said exchange of monetary value occurs between a merchant and a consumer via value exchange environment.
